(19) United States
(12) Patent Application Publication
(10) Pub. No.: US 2015/0217893 A1
(43) Pub. Date: Aug. 6, 2015

(54) Label Processor

(71) Applicant: Avery Dennison Corporation, Glendale, CA (US)

(72) Inventors: James P. Lorence, Painesville, OH (US); Mark J. Wyatt, Chino Hills, CA (US); Erik M. Pedersen, Sierra Madre, CA (US); Ronald Haycox, Painesville, OH (US); Raymond Newnes, Mentor, OH (US); John Lyall, Cheshire (GB); Shawn Ross, Parma, OH (US); Nick McClellen, Parma, OH (US); Jeremy Bockmuller, Hiram, OH (US)

(21) Appl. No.: 14/421,909

(22) PCT Filed: Aug. 16, 2013
(86) PCT No.: PCT/US2013/055244

§ 371 Date: Feb. 16, 2015

Related U.S. Application Data
(60) Provisional application No. 61/683,809, filed on Aug. 16, 2012.

(51) Int. Cl. B65C 9/00; B65C 9/24; B65C 9/26; B65C 3/14

(52) U.S. Cl. CPC B65C 9/0015; B65C 3/14; B65C 9/24; B65C 9/26; B65C 2009/0018

(57) ABSTRACT

A deformable label processor and related methods are described. The processor is heated and urged against a label, such as a heat transfer label, to apply one or more designs from the label and/or the label itself onto a container or other surface. The processor and methods are well suited for application of labels onto compound curved surfaces. The label processors include particular exhaust assemblies and air diffuser assemblies.

### CROSS REFERENCES TO RELATED APPLICATIONS

The present application claims priority to U.S. Provisional Application No. 61/683,809 filed Aug. 16, 2012, which claims the benefit of, and is a Continuation-In-Part of, International Application No. PCT/US2010/61272 filed Dec. 20, 2010; and U.S. application Ser. No. 12/973,211 filed Dec. 20, 2010, which both claim priority to, and are Continuations-In-Part of, International Application No. PCT/US2010/43343 filed Jul. 27, 2010, which claims the benefit of U.S. Provisional Application Nos. 61/228,719 filed Jul. 27, 2009, 61/299,165 filed Jan. 29, 29010, and 61/296,715 filed Jan. 20, 2010. The present application also claims priority to, and is a Continuation-In-Part of, U.S. application Ser. No. 12/853,429 filed Aug. 10, 2010. The present application also claims priority to, and is a Continuation-In-Part of, U.S. application Ser. No. 12/532,845 filed Sep. 24, 2009 which is a 371 of PCT/US2008/59397 filed Apr. 4, 2008, and claims the benefit of U.S. Provisional Application Nos. 60/910,282 filed Apr. 5, 2007, and 60/938,019 filed May 15, 2007. The present application also claims priority to, and is a Continuation-In-Part of, U.S. application Ser. No. 12/237,737 filed Sep. 25, 2008, which is a Continuation-In-Part of PCT/US2008/59397 filed Apr. 4, 2008, and claims the benefit of U.S. Provisional Application Nos. 60/910,282 filed Apr. 5, 2007 and 60/938,019 filed May 15, 2007. The present application also claims priority to, and is a Continuation-In-Part of, U.S. application Ser. No. 12/237,761 filed Sep. 25, 2008, which is a Continuation-In-Part of PCT/US2008/59397 filed Apr. 4, 2008, and claims the benefit of U.S. Provisional Application Nos. 60/910,282 filed Apr. 5, 2007 and 60/938,019 filed May 15, 2007. The present application also claims the benefit of U.S. Provisional Application No. 61/299,151 filed Jan. 27, 2010. All of the previously noted applications are incorporated herein by reference in their entireties.

### FIELD

The present subject matter relates to equipment and methods for applying labels to a curved surface, and particularly to a compound curved surface. The present subject matter also relates to labeling processes and in particular, applying heat transfer labels to containers. The subject matter is particularly directed to application of labels onto curved container surfaces and defect-free retention thereon.

### BACKGROUND

It is known to apply labels to containers or bottles to provide information such as the supplier or the contents of the container. Such containers and bottles are available in a wide variety of shapes and sizes for holding many different types of materials such as detergents, chemicals, personal care products, motor oil, beverages, etc.

Polymeric film materials and film facestocks have been used as labels in various fields. Polymeric labels are increasingly desired for many applications, particularly transparent polymeric labels since they provide a no-label look to decorated glass and plastic containers. Paper labels block the visibility of the container and/or the contents in the container. Clear polymeric labels enhance the visual aesthetics of the container, and therefore the product. The popularity of polymeric labels is increasing much faster than that of paper labels in the package decoration market as consumer product companies are continuously trying to upgrade the appearance of their products. Polymeric film labels also have superior mechanical properties as compared to paper labels, such as greater tensile strength and abrasion resistance.

Traditional polymeric pressure sensitive (PSA) labels often exhibit difficulty adhering smoothly to containers having curved surfaces and/or complex shapes without wrinkling, darting or lifting on the curved surfaces. As a result, heat shrink sleeve labels have typically been used on these types of containers having compound curved surfaces. Labeling operations for sleeve type labels are carried out using processes and methods that form a tube or sleeve of the heat shrink film that is placed over the container and heated in order to shrink the film to conform to the size and shape of the container. Alternatively, the containers are completely wrapped with a shrink label using a process in which the shrink film is applied to the container directly from a continuous roll of film material and then heat is applied to conform the wrapped label to the container. Regardless, label defects frequently occur during labeling operations of simple or compound shaped bottles during label application or in post label application processes. These misapplied labels result in high scrap or extra processing steps that can be costly.

Accordingly, a need exists for a process and associated labeling equipment in which a design and/or indicia could be applied to a curved surface and particularly a compound curved surface without the occurrence of defects.

Eliminating or reducing the previously noted problems may also lead to additional advantages such as reducing overall capital costs for process equipment, reducing floor space associated with a labeling process, increasing equipment life by reducing exposure to heat, and improving process consistency and reliability as a result of process simplification.

### SUMMARY

The present subject matter provides advances in labeling operations, and particularly for methods of applying designs to articles by heat transfer labeling.

The difficulties and drawbacks associated with previously known systems and methods are overcome in the present articles and methods relating to a heated flexible member that readily and consistently applies one or more designs to containers using heat transfer label assemblies, and particularly containers with compound curved surfaces, while minimizing the occurrence of defects.

In one aspect, a label processor is provided comprising a rigid frame defining a front face and an oppositely directed rear face, and a flexible member sealingly attached to the frame. The flexible member also defines an outer face for contacting a label. The flexible member also defines a hollow interior region. The flexible member is deformable upon application of a label contacting force to a portion of the member. The rigid frame defines at least one air inlet and at least one air outlet in communication with the hollow interior region defined by the flexible member. The label processor also comprises an air diffuser assembly disposed within the hollow interior region defined by the flexible member. The air diffuser assembly is in communication with the at least one air inlet such that air entering the air inlet travels through at least a portion of the air diffuser assembly to reach the hollow interior region defined by the flexible member.

In another aspect, a label processor is provided comprising a rigid frame defining a front face and an oppositely directed rear face. The frame defines an opening extending between the front and rear faces. The label processor also comprises a flexible member extending through the opening defined in the frame and projecting outward from the front face of the frame. The flexible member defines an outer face for contacting a label. The flexible member defines a hollow interior region. The flexible member is deformable upon application of a label contacting force to a portion of the member. The label processor also comprises a vent plate defining a front face and an oppositely directed rear face. The front face of the vent plate is directed toward the rear face of the frame. The vent plate defines at least one air inlet and at least one air outlet in communication with the hollow interior region defined by the flexible member. The label processor also comprises an exhaust assembly in communication with the at least one air outlet. The exhaust assembly includes a valve for adjusting air pressure within the hollow interior of the flexible member.

In still another aspect, a label processor is provided comprising a rigid frame defining a front face and an oppositely directed rear face, and a flexible member sealingly attached to the frame. The flexible member defines an outer face for contacting a label. The flexible member defines a hollow interior region. The flexible member is deformable upon application of a label contacting force to a portion of the member. The rigid frame defines at least one air inlet and at least one air outlet in communication with the hollow interior region defined by the flexible member. The label processor also comprises an exhaust assembly in communication with the at least one air outlet. The label processor also comprises an air diffuser assembly disposed within the hollow interior region defined by the flexible member. The air diffuser assembly is in communication with the at least one air inlet such that air entering the air inlet travels through at least a portion of the air diffuser assembly to reach the hollow interior region defined by the flexible member.

In yet another aspect, a method for promoting label application to a container by use of a label processor, is provided. The processor includes (i) a frame; (ii) a flexible member sealingly attached to the frame, the flexible member defining an outer face for contacting a label, the flexible member defining a hollow interior region, the flexible member being deformable upon application of a label contacting force to a portion of the member, and (iii) an air diffuser assembly disposed within the hollow interior region defined by the flexible member. The method comprises directing air at a pressure greater than the pressure within the hollow interior region defined by the flexible member, into the air diffuser assembly. The method also comprises distributing the air within the hollow interior region defined by the flexible member as the air directed into the air diffuser, exits the air diffuser.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a front perspective view of a flexible member retained and supported in a preferred embodiment frame assembly and enclosure in accordance with the present subject matter.

FIG. 2 is another front perspective view revealing an interior region of the flexible member, frame assembly, and enclosure depicted in FIG. 1.

FIG. 3 is a rear perspective view of the flexible member, frame assembly, and enclosure of FIGS. 1 and 2.

FIG. 4 is a cross sectional view of the flexible member, frame assembly, and enclosure taken across line AA in FIG. 3.

FIG. 5 is a front perspective view of a flexible member retained and supported in another preferred embodiment frame assembly and enclosure in accordance with the present subject matter.

FIG. 6 is another front perspective view revealing an interior region of the flexible member, frame assembly, and enclosure depicted in FIG. 5.

FIG. 7 is a front perspective view of a flexible member retained and supported in another preferred embodiment frame assembly and enclosure in accordance with the present subject matter.

FIG. 8 is a cross sectional view of the flexible member, frame assembly, and enclosure taken across line BB in FIG. 7.

### DETAILED DESCRIPTION OF THE EMBODIMENTS

Specifically, the present subject matter provides a flexible label applicator or processor member and associated assembly that when used in accordance with a preferred technique as described herein, applies labels onto curved surfaces without attendant problems of the occurrence of defects such as darts and wrinkles. The technique results in the application of labels onto curved container surfaces without defects by using a unique concurrent heating and wiping operation.

The flexible member, its various characteristics, and various frames and related assemblies for supporting and using the member are all described in greater detail herein. In particular, the use of certain exhaust assemblies and air diffuser assemblies are described. Additionally, preferred aspects of labels and films for application to containers are also described herein. Moreover, preferred aspects of adhesives associated with the labels and other aspects and details of labels are described herein. Furthermore, preferred processes for applying labels by use of the flexible member(s) are all described in greater detail herein.

### Flexible Member

The present subject matter provides a flexible member or diaphragm that is adapted for contacting a label, label assembly, film(s), or other like components and applying pressure to the label to contact and adhere the label to a surface of a container. Typically, labels are applied to the outer surface of a container, which as previously noted, is curved or otherwise exhibits a curved contour or shape. In many instances, certain regions of the container may exhibit compound curves. By use of the present subject matter, labels may be applied over these regions in a defect-free manner.

The flexible member is sufficiently rigid such that the member maintains its shape prior to contact with the label(s) or container(s). The member is not overly rigid, and hence flexible, such that the member readily deforms upon contact and under application of a load, such as for example, a label contacting force. This preferred characteristic is described in greater detail herein, but generally designated by reference to the flexible member as being deformable.

The flexible member may be provided in a wide variety of different shapes, sizes, and configurations so long as it exhibits the noted deformable feature. Preferably, the flexible member defines an outwardly bulging or domed surface such as a convex surface for contacting a label and/or container. The flexible member also defines an interior hollow region, preferably accessible from a location opposite that of the outwardly bulging contact surface.

It is also preferred that the flexible member provide heat to the label and/or container. Accordingly, it is preferred that the flexible member transfer heat along at least a portion of its outer surface, and preferably along its outwardly bulging surface for subsequent transfer of such heat to a label and/or container, particularly when contacting the label. Heat may be provided along the surface of the flexible member in a variety of different ways. However, it is generally preferred that a source of heat be provided within the interior of the flexible member. Heat within the interior of the flexible member is then transmitted through a wall of the flexible member, such as by conduction, to the outer surface of the member. It will be understood that the present subject matter includes flexible members that do not include any heating provisions. In this version of the subject matter, one or more preheaters are used to heat the labels and/or films.

A preferred source of heat for the flexible member is a flameless heater such as an electrically powered resistive heater. Alternatively, one or more coils of a conduit through which a heated medium is passed could also be positioned within the interior of the flexible member. Yet another source of heat is administering a heated medium directly within the hollow interior of the flexible medium. Examples of such mediums include but are not limited to air, other gases, fluids, or flowable liquids. For example, liquid hydrocarbons such as oils could be used to heat and/or fill the interior hollow region of the flexible member. However, air is often preferred since it is readily available and leakage is not a concern.

For embodiments in which a heating coil or heating unit is provided within the interior of the flexible member, the particular configuration of the coil or unit may be provided so as to optimize the transmission of heat to desired regions of the flexible member, e.g. outer peripheral regions of the region of the domed outer surface. Generally, the preferred configuration or pattern of the heater is dependent on the particular geometry of the bottle and its respective label, to which the flexible member is contacted. Preferably, an oval or circular pattern can be used, with the heater being positioned relatively close to the interior wall surface of the flexible member along regions corresponding to outer regions of the label being applied thereto. This is preferred because it is generally not necessary to heat portion(s) of the label that are already adhered to the container, e.g. the interior middle region(s). This is explained in greater detail herein.

In the preferred versions of the flexible member, the outer domed region and sometimes the sidewalls attached thereto, are flexed, deformed and moved as the member is contacted against a container and label. Thus, it is generally preferred that any heating provisions such as for example electrically resistive heating elements, not be directly attached to the flexible member. However, the present subject matter contemplates that such constructions and arrangements could be used. For example, flexible printed heating elements could be applied onto the inner surface or the outer surface of the flexible member. It is also contemplated that an electrically powered resistive heater could be formed within or otherwise disposed within the flexible member.

Heating of the domed label-contacting outer surface of the flexible member can be accomplished in nearly any fashion. For example, multiple heating sources, provisions, and/or other techniques may be used. In certain applications, it may be preferred to employ multiple heaters. For example, a first heater can be used to heat air entering the interior hollow region of the flexible member. The first heater can for example be an electrically powered resistive heater. A second heater can be provided within the interior of the flexible member and be relatively stationary. The second heater can be in the form of an electrically powered resistive heater or utilize one or more coils through which a heat transfer fluid flows. Heating of the flexible member is performed such that the outer temperature of the flexible member is at least 38° C. and most preferably from about 120° C. to about 150° C. during label application operations. It will be appreciated that the temperature or range of temperatures to which the outer surface of the flexible member is heated, depends upon numerous factors, including for example, the heat shrink characteristics of the label and the adhesive properties. It is also contemplated that another set of heaters could be used to heat the labels and/or the containers prior to their contact with the flexible member. These heaters can be positioned external to the flexible member. For example, one or more infrared heaters could be utilized. Infrared lamps are preferred since they tend to heat objects of interest, i.e. the labels, and do not heat the surrounding atmosphere. Preferably, for certain applications, the labels are heated to a temperature of at least 38° C. prior to their final application to a container. A wide array of heating strategies and techniques can be used in order to increase the temperature of the external surface of the flexible member.

For certain preferred embodiments, it is desirable to utilize a single heat source. That is, for certain applications it is preferred to use one or more inlet heaters to heat incoming air during or prior to its entrance into the flexible member, and not employ one or more heaters within the flexible member. Heaters provided within the interior of a flexible member are preferably radiant heaters. Elimination or avoidance of such interior heaters may provide significant cost savings. However, it will be appreciated that the present subject matter includes systems in which heating is provided exclusively within the flexible member, systems in which heating is provided by both inlet heaters and heaters within the flexible member, and by systems using tertiary or other supplemental heaters in combination with inlet heaters and/or heaters within the interior of the flexible member.

Another feature provided in certain preferred embodiments relates to the use of one or more air manifolds generally positioned within a flexible member. In a preferred system configuration, heated air is continuously cycled through one or more flexible members during a labeling operation. Excess air is exhausted as one or more flexible members are contacted and pressed against corresponding containers carrying labels. New air is then introduced upon positioning the flexible member away from and no longer in contact with the container and label. It is preferred that the new air is heated as such practice avoids the use of ambient temperature air which would otherwise cool the flexible member.

Many of the preferred embodiment flexible member, frame, and/or enclosure assemblies utilize a single entrance for incoming heated air along a rear wall that encloses the interior of the flexible member. Directing heated air into the flexible member interior and particularly, through a single entrance, results in the creation of regions of higher temperatures along the flexible member. Such regions of non-uniformity are undesirable.

Accordingly, for certain applications, it is preferred to use an air manifold or diffuser assembly within the interior of a flexible member. The air manifolds may be in a wide array of shapes and sizes. The air manifolds serve to distribute heated air within the interior of a flexible member to thereby more uniformly heat the flexible member.

The air flow manifold or diffuser may be in a variety of different shapes, sizes, and/or configurations. For example, one or more diffuser plates may be provided against which incoming heated air is directed toward. The flowing airstream is deflected by the diffuser plate(s) and thereby directed to other regions within the interior of the flexible member. The diffuser plate can be positioned directly within the flowing air stream such as by securing the plate across the opening of an air inlet port. Other members can be used in combination with a diffuser plate such as one or more pins or other flow deflecting members. Generally, any member that induces or promotes turbulence of the air flow within the interior of a flexible member may be used.

A particularly preferred embodiment of an air manifold is a tube diffuser. A tube diffuser is preferably in the form of a pipe or conduit in flow communication with the heated air inlet and is sized and shaped so as to fit within the interior of a flexible member. The pipe or conduit defines a longitudinally extending interior flow channel. The pipe or conduit also defines a plurality of holes or other apertures in the sidewalls and any end walls of the pipe. Air entering a flexible member through the inlet is directed through the pipe and exits the pipe via the plurality of holes. The pattern or arrangement of apertures is such that the heated air exiting the pipe uniformly heats, or substantially so, the interior of the flexible member and preferably the front wall of the flexible member which ultimately contacts labels. For example, a representative pattern of apertures may include two rows of apertures extending along the length of the pipe. Each hole or aperture is approximately 1.5 mm in diameter, and spaced about 25 mm apart. The two rows are spaced 60° apart and are directed toward the inner sides and front surfaces within the interior of the flexible member. Such orientation of the rows serves to direct heated air to the lateral side regions of the flexible member where such heat is typically needed.

The interior hollow region of the flexible member may be open or in communication with the atmosphere and thus be at atmospheric pressure. Alternatively, communication between the interior region and the external atmosphere may be partially or entirely restricted, such that the interior region is at a pressure that is greater than or less than atmospheric pressure. The flexible member may also be configured or engaged with other components such that during deformation of the flexible member, the pressure within the interior hollow region of the member changes, and is different from the pressure within that region prior to deformation. For example, a preferred configuration as described in greater detail herein, provides partially restricted communication between the interior hollow region of the flexible member and the external atmosphere. Prior to deformation, the restriction is not complete so that the interior hollow region is at atmospheric pressure. Upon deformation, the volume of the interior hollow region is reduced. Due to the noted partial restriction and decrease in volume, the pressure within the interior hollow region of the flexible member increases to a pressure greater than atmospheric pressure. The increase in pressure is preferably temporary as air within the interior hollow region is allowed to exit the interior region of the flexible member. These aspects are described in greater detail herein.

Preferably, the flexible member is not pressurized prior to a label application process. That is, preferably, the interior hollow region of the flexible member is at atmospheric pressure. By selectively controlling the flow restriction of air exiting the flexible member during a label application operation, controlled increase and maintenance of pressure within the flexible member is achieved. Preferably, the contents of the flexible member are exhausted after each label application operation so that the pressure within the interior of the flexible member returns to atmospheric. Preferably, the peak pressure as measured within the interior hollow region of the flexible member is less than 34,500 N/m², more preferably less than 27,600 N/m², and most preferably less than 20,700 N/m². However, it will be understood that the present subject matter includes other venting strategies and the use of peak pressures lesser than or greater than these noted. Generally, over the course of a label application operation, a somewhat steady and constant inflow of air to the flexible member is provided through open exhaust ports. The flexible member will partially deflate as it contacts the label and container and in certain instances, may collapse as it fully contacts the label and container.

It will be appreciated that the present subject matter may utilize a wide array of assemblies in addition to or in certain applications, instead of, the flexible members described herein for applying a label or film onto a curved surface. For example, various mechanical assemblies particularly using springs or other biasing members could be used. It is also contemplated that label applicator or label processing members using compressible foams could be used.

The flexible member may be formed from nearly any material so long as the member is sufficiently flexible, i.e. deformable, and exhibits good thermal conductivity, durability, and wear properties. A preferred class of materials for the flexible member is silicones.

More precisely called polymerized siloxanes or polysiloxanes, silicones are mixed inorganic-organic polymers with the chemical formula [R₂SiO]ₙ, where R is an organic group such as methyl, ethyl, or phenyl. These materials typically include an inorganic silicon-oxygen backbone ( . . . —Si—O—Si—O—Si—O— . . . ) with organic side groups attached to the silicon atoms, which are four-coordinate.

In some cases, organic side groups can be used to link two or more of these —Si—O— backbones together. By varying the —Si—O— chain lengths, side groups, and crosslinking, silicones can be synthesized with a wide variety of properties and compositions. They can vary in consistency from liquid to gel to rubber to hard plastic. The most common siloxane is linear polydimethylsiloxane (PDMS), a silicone oil. The second largest group of silicone materials is based on silicone resins, which are formed by branched and cage-like oligosiloxanes.

A particularly preferred silicone for use in forming the flexible member is a commercially available silicone elastomer designated as Rhodorsil® V-240. Rhodorsil® V-240 is available from Bluestar Silicones of Rock Hill, S.C. This silicone elastomer is a two component, addition cure, room temperature or heat accelerated cure silicone rubber compound. It is designed as a 60 Durometer (Shore A) rubber with high strength properties, long library life, low shrinkage, excellent detail reproduction, good release characteristics, and improved resistance to inhibition. The formulation of Rhodorsil® V-240 is generally as shown in Table 1 below:

TABLE 1
Formulation of Rhodorsil ®

| Component | CAS Reg Number | Percentage |
|---|---|---|
| Methylvinylpolysiloxane | — | |
| Quartz (SᵢO₂) | 14808-60-7 | 15-40 |
| Filler | — | |
| Calcium Carbonate | 471-34-1 | 1-5 |
| Platinum Complex | — | <0.1 |

As explained herein, in certain applications, it is desirable to heat the label prior to or during application, of the label to the surface of interest. And, as previously noted, heating provisions can be incorporated within the interior hollow region of the flexible member. Accordingly, it is desirable that the material of the flexible member exhibit a relatively high thermal conductivity to promote heat transfer to the outer surface of the flexible member. Preferably, the thermal conductivity of the flexible member is at least 0.1 W/(m·° C.), more preferably at least 0.15 W/(m·° C.), more preferably at least 0.20 W/(m·° C.), more preferably at least 0.25 W/(m·° C.), and most preferably at least 0.275 W/(m·° C.).

For embodiments in which the flexible member is formed from a silicone elastomer, the thickness of the walls of the flexible member are preferably from about 2.3 mm to about 3.0 mm. It will be understood that the particular wall thickness depends upon material selection, desired deformability characteristics, and other factors. Accordingly, in no way is the present subject matter limited to these wall thicknesses.

Most preferably, the flexible member is a domed outwardly projecting deformable member. The member may include one or more arcuate side walls or a plurality of straight walls arranged so as to form the interior hollow region. In a preferred version, the flexible member includes four side walls that extend between a base and a domed label-contacting surface. The four walls are arranged transversely with neighboring walls so as to form a square or rectangular shape. The base is preferably in the form of a lip that extends along a common edge of the four side walls. The domed surface extends from an edge of the side walls opposite the lip. The entire flexible member, i.e. its base, side walls, and domed surface, can be readily formed by molding a silicone elastomer, such as the previously noted Rhodorsil® V-240. The exact shape, size, and configuration of the flexible member primarily depends upon the shape, size, and configuration of the bottle to which a label is to be applied. For many applications, the flexible member may be in the shape of an oval with a domed front face. However, it will be appreciated that the present subject matter includes flexible members of nearly any shape.

The particular shape and/or configuration of a flexible member primarily depends upon the shape of the label and the shape or contour of the container. Although for many applications, a flexible member having a generally rectangular and symmetrical frontal profile with arcuate or rounded edges may be suitable, for certain applications, it may be preferred to use flexible members having non-symmetrical frontal and/or side profiles. Examples of flexible members having non-symmetrical profiles are provided and described herein.

### Flexible Member Frame and Assembly

The present subject matter also provides a frame for supporting the flexible member and preferably engaging the member to facilitate positioning and contacting the member against a label and/or container. The frame is preferably rigid and may be constructed from one or more metals, polymeric materials, or composite materials exhibiting the requisite properties as more fully described herein.

Preferably, in one form, a frame having a relatively planar shape defining two oppositely directed sides and defining a relatively large central opening is provided. The opening is sized and shaped to accommodate and receive the flexible member. Accordingly, upon positioning the flexible member within the frame's opening, the frame extends about the flexible member and provides support for the member and facilitates movement or positioning of the flexible member. In a preferred embodiment, the flexible member includes a plurality of side walls. Thus, preferably, the frame defines an opening having the same shape as the plurality of side walls of the flexible member. For collections of linear side walls of a flexible member, the shape of the opening defined in the frame preferably corresponds to the shape of the collection of side walls. And, preferably, the number of linear side walls corresponds to the number of interior linear edges of the opening of the frame.

In certain applications, it may be preferred to provide one or more guides extending from the frame and generally alongside the flexible member when coupled with the frame. The one or more guide(s) are positioned and oriented relative to the flexible member such that they serve to limit the extent and/or direction of deformation of the flexible member. The guides may be affixed or otherwise formed with the frame by techniques known in the art. The guides are preferably located about the previously noted frame opening. The guides preferably extend or otherwise project from a face of the frame, and in certain embodiments, may extend transversely therefrom.

Each guide may also comprise one or more additional components or may itself extend in a desired direction relative to the flexible member. For example, an adjustably positionable secondary guide member may be provided along a distal end region of a guide. The secondary guide member may extend transverse to, or at some angle, with respect to the longitudinal axis of the guide. The position and specifically, the angular orientation of the secondary guide is preferably selectable so that a user may vary the orientation and position of the secondary guide member relative to the flexible member as desired.

Yet another preferred feature in many of the embodiments is the provision of guides having particular shapes or profiles along their inner faces, i.e. the faces of guides that are directed toward a flexible member. The use of shaped or contoured inner sides of guides promotes improved contact between flexible members and containers/labels. For certain containers having curved or sloping sidewall and/or arcuate front or rear faces, the use of guides having contoured inner sides promotes rolling contact between the flexible member and label. In addition, the provision of guides having inner sides that match or generally correspond to the contour of the container sides promotes further displacement of the flexible member around the contour of the container. Furthermore, the use of guides having inner sides that correspond to the shape of the container has also been found to promote label application of corner and outer end regions of the label to the container.

The frame is preferably formed from steel or aluminum, although a wide array of other materials are contemplated. The guides and/or the secondary guide members are also preferably formed from steel or aluminum. The guides can be integrally formed with the frame. Alternatively, the guides can be affixed to the frame after formation of the frame such as by welding or by the use of one or more fasteners. As noted, it is preferred that the secondary guide member(s) be positionable with respect to the guide(s) and/or the frame. And so, it is preferred that a selectively positionable assembly be used to releasably affix each secondary guide to a corresponding guide.

The present subject matter also provides an enclosure or other mounting assembly. Preferably, the frame and/or the flexible member are attached to the enclosure. The enclosure is preferably sized, shaped, and configured to be affixed to or otherwise secured to the frame. The enclosure may also serve to house heating provisions for the flexible member. These aspects are all described in greater detail herein.

Additionally, for certain embodiments it may be preferred to provide adjustment assemblies such that the position of the guides can be selectively adjusted relative to the frame. Such adjustment assemblies can be provided in many forms, however a preferred assembly includes a pair of vertically oriented rails upon which the guides can be selectively positioned and engaged. The use of such an adjustment assembly enables the vertical position of one or more guides to be readily and conveniently positioned as desired. Vertical positioning of a guide may be desirable to accommodate application of labels of different sizes and/or placement positions on the containers of interest.

The assembly of frame and enclosure, and ultimately including the flexible member, may further include one or more additional components. As previously noted, heating provisions are preferably provided within the interior hollow region of the flexible member. Preferably, such heating is provided by one or more electrically powered resistive heating element(s). The element can be in a variety of different shapes and configurations. Also, as previously noted, a conduit carrying a flowable heating medium can be positioned in the interior hollow region of the flexible member. It is generally preferred that appropriate insulating members be provided in association with the heating element to prevent direct contact with the flexible member. However, if the flexible member is formed from a material that is sufficiently resistant to high temperatures such insulating members may not be necessary.

The assembly of frame, flexible member, and enclosure preferably further includes a vent plate that extends across the open rear region of the flexible member. The vent plate provides access to the interior hollow region of the flexible member. Upon incorporation in the assembly, the vent plate contacts, and preferably sealingly contacts a rearwardly directed face of the flexible member and/or the frame. The vent plate preferably defines one or more openings extending through the vent plate that allow air to pass. Air can be introduced through these openings to pressurize the interior of the flexible member and/or to heat the flexible member. Upon deformation of the flexible member, such as after contact with a label and container, air is directed out of the hollow interior of the flexible member through the one or more openings defined in the vent plate. The total flow area of the openings of the vent plate can be selected or varied such that the rate of air exiting or entering the flexible member is limited or otherwise controlled. This strategy can be utilized to slow the rate of deformation of the flexible member. These aspects are described in greater detail herein.

In certain applications, particularly those involving high volume manufacturing, it is preferred to utilize multiple assemblies of frame(s), flexible member(s) and/or enclosure(s) such as in a parallel configuration in which the components are alongside one another.

Another optional feature of the present subject matter is the provision of a “quick change” head assembly. In these embodiments, a releasable head assembly which carries a flexible member, optional heater(s) within the flexible member, frame, and electrical components is provided. The releasable head assembly can be readily engaged with and removed from a larger frame or support assembly, or with a walking beam apparatus as known in the art. The provision of a releasable head assembly enables fast and efficient changing of one flexible member and associated assembly for another flexible member and its associated assembly. This may be desirable when the use of a flexible member having a particular configuration is preferred over another flexible member having a different configuration. The releasable head assemblies are preferably configured such that they are easily engageable or securable to the other frame or walking beam apparatus. Electrical power and signal connections are preferably made by plug connections, although the subject matter includes the use of other connecting systems. These and other aspects are described in greater detail herein in conjunction with a description of a representative preferred embodiment.

### Methods

The present subject matter provides a unique process in which a label is selectively and concurrently heated, shrunk, and applied onto a surface of interest, and preferably onto a compound curved surface of a container. The preferred embodiment flexible member is contacted with a label positioned between the flexible member and a surface targeted to receive the label. The domed surface of the flexible member promotes that contact between the label and the flexible member initially occur in a central region of the label, so long as the label and the flexible member are appropriately aligned. The flexible member is urged against the label, which is in contact with the surface of interest. As explained in greater detail herein, in a preferred method, prior to contact between the label and the flexible member, the label is partially in contact with and adhered to the surface of interest, at least along a central portion or region of the label. As the flexible member is urged against the label, further contact occurs between the flexible member and the label which in turn causes increasing contact area between the label and the surface of interest. The areas of contact between (i) the flexible member and the label, and (ii) the label and the surface of interest, increase over the course of label application and typically increase in an outward direction from the central portion of the label and/or the location on the label at which the domed surface of the flexible member first contacts. Greater amounts of area of the flexible member contact the label as the flexible member is further urged against the label. As will be appreciated and described in greater detail herein, the flexible member deforms and adopts the shape of the container surface to which the label is being applied. As a result, the label is fittingly applied onto the container. This feature in conjunction with the manner by which increasing contact occurs, i.e. progressively outward from a central location, is believed to be a significant factor in the resulting defect-free label application.

In addition, in accordance with another aspect of the present subject matter, this strategy is performed using a heated flexible member. This enables concurrent application of heat during progressive outward application of label. For applications in which the label includes a heat shrink material, such as a pressure sensitive heat shrink label, the method is preferably performed such that the label is heated and shrunk to an extent just prior to contact and adhesion with a curved surface so that the label area corresponds to the area of the surface about to receive and contact that region of the label. Any air trapped along the interface of the label and surface of interest is urged outward toward the label edge due to the progressive outward contact by the flexible member. This process is continued until the outer edges of the label are contacted and adhered to the surface of interest.

During application of a label to a container, the flexible member is contacted against the label and container. The amount of force applied to the label by the flexible member is referred to herein as a label-contacting force. Generally, that amount of force depends upon the characteristics of the label, container, and adhesive. However, typically it is preferred that the label contacting pressure be at least from about 690 N/m² to about 6900 N/m². It is to be appreciated however that the present subject matter includes the use of label application forces greater than or lesser than these amounts.

In accordance with the present subject matter, labels are applied utilizing a “center-out” strategy. Thus, contact between the flexible member and the label occurs in a center-out process also. The term “center-out” refers to the order or sequence by which regions or portions of a label are applied or contacted. First, one or more center regions of the label are contacted. Then, as that contact is maintained, one or more additional regions of the label located outward from the center or central region of the label are then contacted. This process is continued such that after contact and adherence of the label regions located outward from the center regions, that contact is maintained and one or more additional regions of the label located further outward from the previously noted regions are then contacted. This process is continued until the edge regions of the label are contacted and adhered to the container. Use of this technique ensures, or at least significantly reduces the occurrence of, air bubbles becoming trapped under the label or between the label and container.

The present subject matter includes the use of a wide range of cycling times. For example, in a high volume manufacturing environment, total time periods for one cycle of a flexible member and label/container being displaced toward one another, contacting, the label being adhered to the container, and the flexible member and label/container then being displaced away from another, is from about 0.5 to about 2.0 seconds, with about 0.9 seconds being preferred. The present subject matter includes cycle times greater than or lesser than these values.

A particularly preferred process aspect which may be utilized is referred to herein as a “double hit” operation. For certain labeling operations, it is desirable to apply labels that extend laterally around a container or at least partially so. For example, for a pair of labels that each extend or approach a 180° wrap around a container periphery, it is often difficult to achieve contact between the flexible member and the outer peripheral regions of each label. By use of a double hit strategy, greater contact can occur between a first flexible member and its label on one container face, and a second flexible member and its corresponding label on the other container face. The double hit operation uses a combination of particular stroke delay and/or stroke length of one flexible member relative to that of its opposing flexible member.

Generally, in this particular strategy for applying labels along oppositely directed faces of a container, a first label processor having a flexible member as described herein is progressively contacted with a label on a first face of the container by displacing or moving the member through a first stroke distance toward the container. A second label processor having a flexible member and generally located along an opposite side of the container is also and preferably concurrently contacted with a label on a second face of the container. The second face is generally opposite the first face. The flexible member of the second label processor is progressively contacted with the second label by displacing or moving that member through a second stroke distance toward the container. It is preferred that the first and second stroke lengths are different from one another. For the present description, the first stroke length is greater than the second stroke length. After progressive contact from the first and second flexible members, the members are withdrawn from contact with the container. Then, the process is repeated except that the stroke length of the second label processor is greater than that of the first label processor. Preferably, the stroke length of the second label processor in this second portion of the “double hit” operation is equal to the stroke length of the first label processor in the first portion of the operation.

More specifically, in a preferred double hit operation, a first flexible member on one side of a container is moved toward the container, typically in a direction transverse to the direction of a conveyor on which the container is positioned. Concurrently with movement of the first flexible member, a second flexible member on an opposite side of the container is also moved toward the container, and also in a transverse direction. However, the stroke or distance of movement of the first flexible member is greater than the stroke or distance of the opposing second flexible member. This enables the first flexible member in motion during the longer stroke to more fully wrap around the container and a first label because the second member is not blocking or otherwise hindering wrapping of the first flexible member alongside the outer regions of the container. Upon completion or full stroke of the first flexible member, both flexible members are then retracted. Upon retraction, the first and second flexible members are then again positioned toward the container. However, the second flexible member is fully extended and urged against the container and a second label, while the first flexible member undergoes the shorter stroke. Upon completion of contact between the second label and the second flexible member, the first and the second flexible members are retracted.

The present subject matter also provides various techniques using the label processors described herein. In one technique for promoting label application to a container, air is directed in the hollow interior region defined by the flexible member into an air diffuser assembly which is disposed within that interior region. The air directed into the air diffuser assembly is at a pressure greater than the pressure of air within the hollow interior region. The technique also includes an operation of distributing the air within the hollow interior region defined by the flexible member as the air exits the air diffuser. This technique results in increased temperature uniformity across the outer face of the flexible member. In certain applications, temperature uniformity leads to improved label application characteristics.

The air diffuser can also be utilized to direct air to selected regions along the flexible member. Specifically, in certain applications, heated air is passed through the air diffuser and specifically directed to particular locations along the flexible member. This configuration may be useful for selectively heating desired regions of the flexible member so that a particular temperature profile along an outer face of the flexible member is achieved. For example, for certain labeling operations it may be preferred to direct heated air to perimeter regions of a label to counter the potential for occurrence of “flags” or wrinkles in the label.

Another technique involves the provision of an exhaust assembly and associated valve(s) for directing air from within the interior of the flexible member, to regions external or outside of the flexible member. By selectively adjusting such exhaust valve(s), the pressure within the interior of the flexible bladder can be controlled and/or adjusted as desired. Adjusting the exhaust valve(s) can be performed manually or by non-human means. The term “non-human means” refers to electrical, mechanical, or electro-mechanical provisions such as electrical servo motors or hydraulical actuators to adjust the one or more exhaust valves.

Any one or more of these techniques can be implemented and practiced in conjunction with one or more heaters that increase the temperature of air within the interior of the flexible member.

### EMBODIMENTS

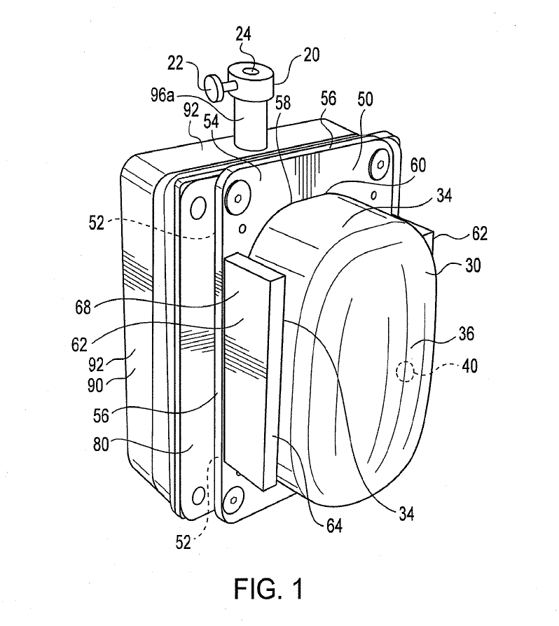

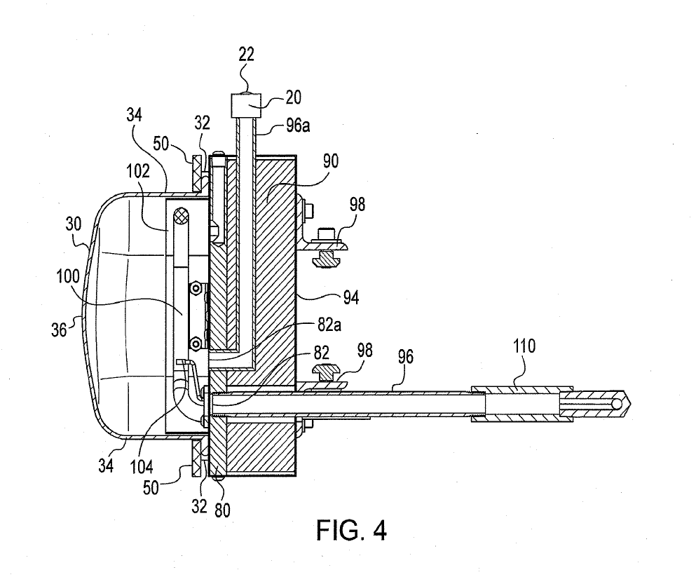

FIGS. 1 to 4 illustrate a preferred assembly of the previously described flexible member 30 retained, supported, and mounted by a frame 50 and an enclosure 90. FIG. 1 illustrates the assembly only partially assembled to reveal a vent plate 80 generally disposed rearwardly of the flexible member 30. As generally shown in FIG. 1, the frame 50 defines a rearwardly directed first face 52, a second oppositely directed, i.e. forwardly directed, second face 54, an outer edge 56 extending about the outer periphery of the frame 50 and between the faces 52 and 54, and an inner edge 58. The inner edge 58 defines an opening 60 that is preferably sized and shaped to receive the flexible member 30. In the illustrated embodiment, the opening 60 is rectangular with rounded or arcuate corners. This shape corresponds to the shape of a collection of side walls 34 of the flexible member 30. It will be understood that the present subject matter includes nearly any shape for the opening 60. Preferably, the frame 50 is flat or relatively planar. The flexible member 30 is inserted through the opening 60 defined in the frame 50. Preferably, an outwardly extending base 32 (best shown in FIG. 4) of the flexible member 30 contacts and is disposed immediately adjacent to the first face 52 of the frame 50. And, the side walls 34 and a domed region 36 of the flexible member 30 extend through the opening 60 and outward beyond the second face 54 of the frame 50.

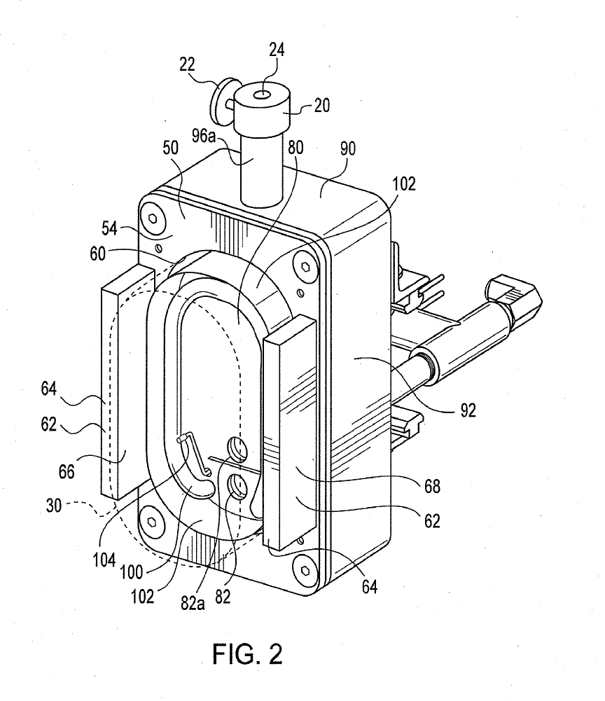

FIG. 1 also illustrates one or more guides 62 that are preferably provided in conjunction with the frame 50. The one or more guides 62 are preferably affixed to or otherwise formed with the frame 50 and preferably project from the second face 54 of the frame 50. The guides 62 generally define a distal edge 64, an inner wall 66 (see FIG. 2) and an oppositely directed outer wall 68. In certain applications, the guides 62 are preferably located proximate the opening 60 defined in the frame 50. In the embodiment depicted in FIGS. 1 to 2 for example, two guides 62 are utilized, arranged along opposite sides of the opening 60 defined in the frame 50. However, it will be appreciated that in numerous other applications the guides can be located elsewhere. For example, the guides may be positioned so as to distort the flexible member to a shape other than its natural or default shape. And, the guides 62 are preferably oriented parallel to each other and parallel to the longitudinal axis of the semi-rectangular shaped opening 60. FIG. 1 also illustrates that the guides 62 extend an equal distance from the second face 54 of the frame 50, and may extend from about 10% to about 100% of the distance to which the flexible member 30 extends from the second face 54. For many applications, it is preferred that the guides 62 extend to a distance as measured from the second face 54 of the frame, that is about 25% to about 75% of the distance measured between the second face 54 and the distalmost location 40 of the flexible member 30.

Referring to FIGS. 1 to 4 further, the assembly also includes an enclosure 90. Preferably, the enclosure 90 is a housing or other structure for mounting and retaining various components. Generally, the enclosure 90 includes one or more walls 92 and a rear wall 94. Walls 92 can include a top wall, a bottom wall, and opposing side walls. One or more conduits 96 and mounting provisions 98 can be provided, preferably along the rear of the enclosure.

As previously noted, FIG. 1 also illustrates a vent plate 80 used in the preferred assembly. The vent plate 80 defines one or more vent passages 82 and 82a as illustrated in FIG. 2 extending through the plate 80 to allow a fluid such as air to enter and exit the interior hollow region of the flexible member 30. As shown in FIG. 1, the vent plate 80 is preferably positioned between the frame 50 and the enclosure 90.

FIG. 2 illustrates the assembly of FIG. 1 fully assembled, with the flexible member 30 shown in dashed lines thereby revealing the interior of the flexible member 30. As noted, it is preferred to provide a heat source within the flexible member 30. Accordingly, the assembly includes a heater 100 preferably disposed within the interior hollow region of the flexible member 30. As previously noted, the heater can be in many different forms. For the present embodiment, the heater 100 is an electrically powered resistive heater such as a 480 volt 600 watt heater. A reflector 102 or other protective shield is preferably provided. The reflector 102 preferably extends between the heater 100 and the sidewalls 34 (not shown) of the flexible member 30. The reflector 102 may include a reflective surface to reflect radiant heat energy from the heater 100 away from an adjacent sidewall 34 of the flexible member 30. One or more temperature sensors 104 can be disposed in the interior of the flexible member 30 to obtain information as to heating and temperature conditions. FIG. 2 also illustrates a portion of the vent plate 80 and vent passages 82 and 82a defined in the plate 80.

In certain embodiments it may also be preferred to provide one or more exhaust or vent lines that direct air (or other fluid) from the interior of the flexible member 30 to the exterior of the enclosure 90. FIGS. 1-4 depict the use of an exhaust conduit 96a that provides flow communication between an aperture 82a defined in the vent plate 80 to the exterior of the enclosure 90 via an outlet 24. The exhaust conduit 96a defines a longitudinally extending interior flow channel. The flow channel of the conduit 96a extends between the outlet 24 and the aperture 82a. The exhaust conduit 96a typically extends within a region of the enclosure 90 and projects outward therefrom as shown. One or more flow control valves 20 having flow control provisions 22 are preferably provided along the exhaust conduit 96a. The flow control provisions govern flow of fluid such as air within the exhaust conduit. The flow control provisions 22 may be manually adjustable or controlled by other means known in the art such as by electric servo controllers or vacuum operated controllers. Adjustment of the flow control provisions 22 enable adjustment or control of the pressure and change in pressure within the interior of the flexible member 30.

Although in certain embodiments it is preferred to utilize an exhaust conduit 96a with a control valve 20 as depicted in FIG. 2, the present subject matter also includes the use of one or more exhaust conduits 96a without any control valve(s) 20. In addition, the present subject matter additionally includes embodiments in which the interior of the enclosure 90 is vented by one or more apertures in the enclosure.

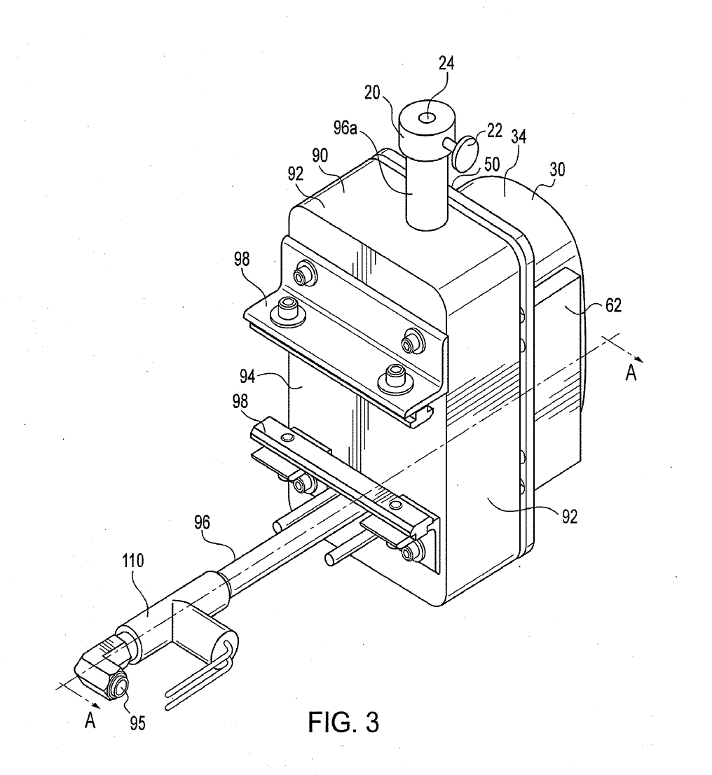

FIGS. 3 and 4 illustrate additional components and provisions of the preferred assembly of the flexible member 30, the frame 50, and the enclosure 90. One or more conduits 96 preferably extend from the rear wall 94 of the enclosure 90 and serve to direct air or other fluid into the interior of the flexible member 30. Air, typically under pressure, is directed into an entrance 95 defined in the conduit 96. Air flowing through the conduit 96 enters the interior hollow region of the flexible member 30 through the vent passage 82.

A preheater 110 can be provided such as inline or otherwise in flow communication with the conduit 96. The heater 110 serves to heat air or other fluid entering the conduit 96 to lessen the heating burden otherwise imposed upon the heater 100 disposed within the flexible member 30. It will be understood that the preheater 110 may include an integral section or portion of conduit. Although a wide array of heating devices and strategies can be used for the preheater 110, a preferred heater is an electrically powered resistive heater such as a 170 volt 1,600 watt heater available from Sylvania of Exeter, New Hampshire.

The present subject matter includes assemblies using one or more heaters disposed within the interior of the flexible member such as heater 100 shown in FIG. 2, one or more heaters disposed outside of the flexible member such as heater 110, or combinations of such heaters. In certain embodiments, the internal heater(s) 100 are not used, and instead the preheater 110 is utilized.

With further reference to FIGS. 3 and 4, it is also preferred to provide one or more mounting provisions 98 on the enclosure, such as along the rear wall 94 of the enclosure 90. The mounting provisions 98 enable convenient and secure affixment of the enclosure 90 including the flexible member 30 to one or more support members.

FIG. 4 is a cross sectional view of the flexible member 30, frame 50, enclosure 90, and conduit 96 taken across line AA in FIG. 3. FIG. 4 illustrates a preferred configuration for the heaters 100 and 110, and the conduit 96 for administering air into and out of the hollow interior of the flexible member 30, through one or more vent passages 82. It will be appreciated that a single vent passage 82 may be used for providing communication between the interior of the flexible member 30 and the conduit 96. Thus, air entering the flexible member 30 travels through the conduit 96 and through the vent passage 82. The present subject matter also includes an air flow configuration in which air enters the flexible member 30 through the conduit 96 and the vent passage 82, and exits the flexible member through one or more other vent passages (not expressly identified in FIG. 4) provided in the vent plate 80 and/or the enclosure 90.

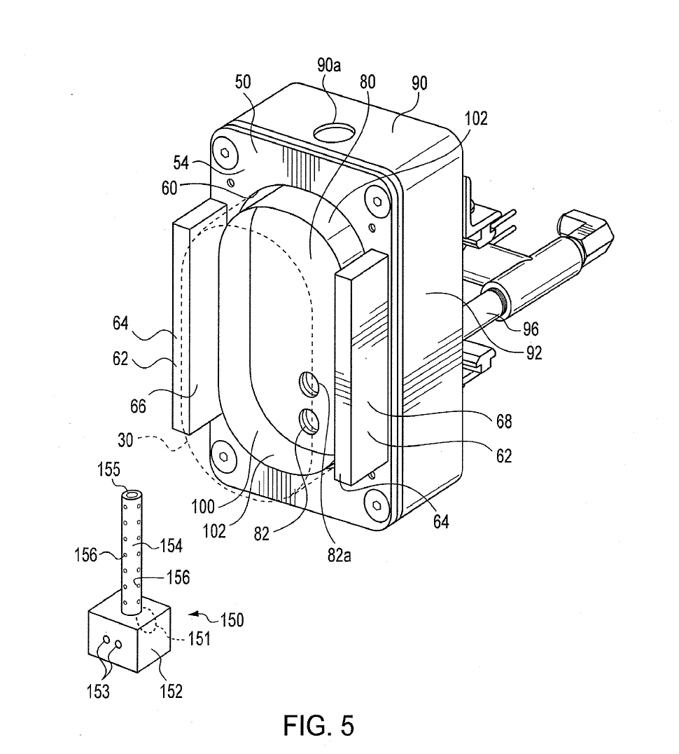

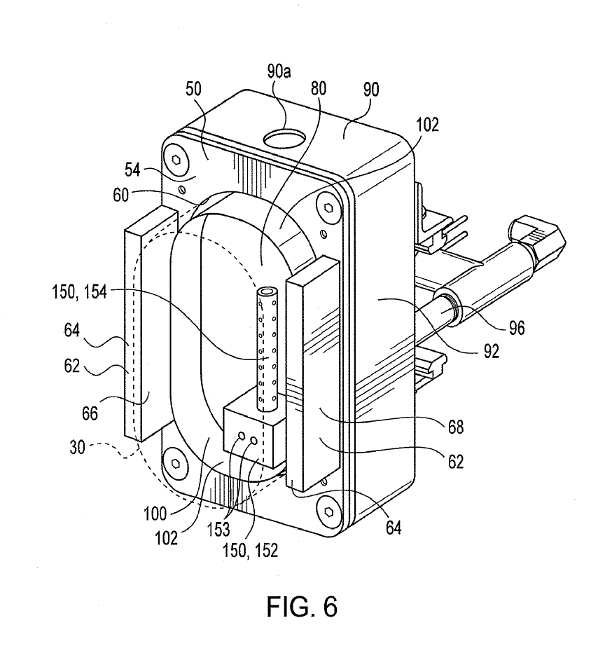

FIGS. 5 and 6 illustrate the previously described flexible member 30 (in dashed lines), frame 50, and enclosure 90 as shown in FIG. 2, without the exhaust conduit 96a and related provisions such as the flow control valve 20. These figures depict provision of a vent aperture 90a defined in the enclosure 90. FIGS. 5 and 6 illustrate another preferred configuration in which an air or tube diffuser assembly 150 is utilized. As previously described, a tube diffuser is a particular type of an air distribution manifold which is disposed within an interior region of the flexible member. The tube diffuser promotes, increases distribution of, and/or selectively directs air within the interior to thereby provide a more uniform temperature over the outer surface of the flexible member and particularly along the outer face of the domed front region of the flexible member 30.

Typically, the tube diffuser 150 comprises a base 152. The conduit 154 preferably defines a longitudinally extending interior flow channel and a plurality of apertures 156. The apertures 156 are typically arranged in rows extending along at least a portion of the length of the conduit 154. The base 152 defines provisions for directing air from the aperture 82 defined in the vent plate 80, to the conduit 154. Typically, an inlet port 151 is defined along a rear face of the base 152 which is sized and configured to sealingly engage the aperture 82. As depicted in FIG. 6, upon incorporation and positioning of the diffuser 150 within the interior of the flexible member 30, the base 152 is typically affixed or otherwise secured to the vent plate 80 such that the aperture 82 is placed in flow communication with the conduit 154. Thus, air flowing through the conduit 96 flows through the aperture 82 into the base 152 via the inlet port 151, and into the conduit 154. Air entering the interior of the flexible member 30 is uniformly distributed therein by the plurality of apertures 156 defined along the length of the conduit 154. One or more apertures 153 may optionally be provided or otherwise defined in the base 152. Preferably, an aperture 155 is also defined at a distal end of the conduit 154. Apertures 153 and 155 provide additional exit locations for air discharged from the diffuser assembly 150.

Referring further to FIGS. 5 and 6, after air exits the diffuser assembly 150, the air is distributed or otherwise selectively directed within the interior of the flexible member 30. Air exits the interior of the flexible member through the aperture 82a defined in the vent plate 80. After entry into the enclosure 90, air exits the enclosure 90 through one or more apertures 90a. Although a single aperture is depicted in FIGS. 5 and 6, it will be appreciated that the present subject matter includes the use of multiple apertures defined along the enclosure 90. It is also contemplated to provide an exhaust assembly such as a conduit extending within the interior of the enclosure 90 between the aperture 82a and the aperture 90a.

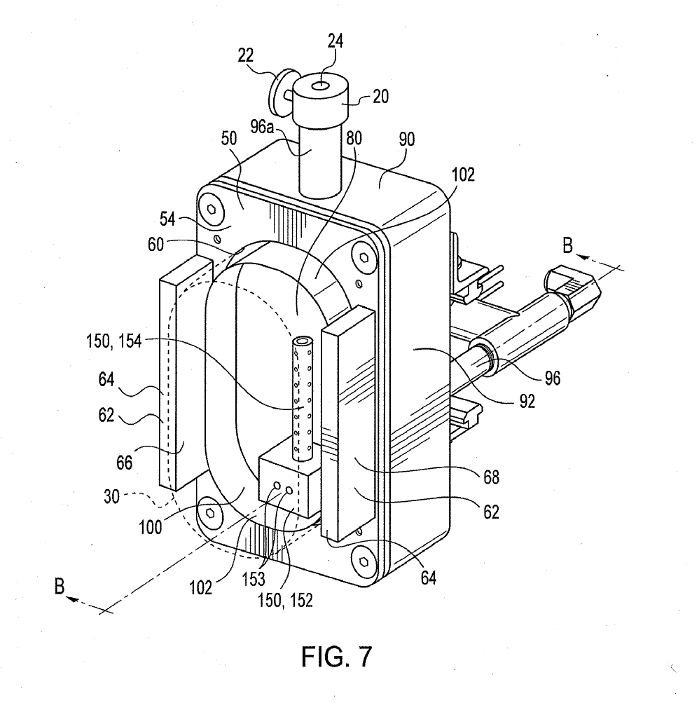

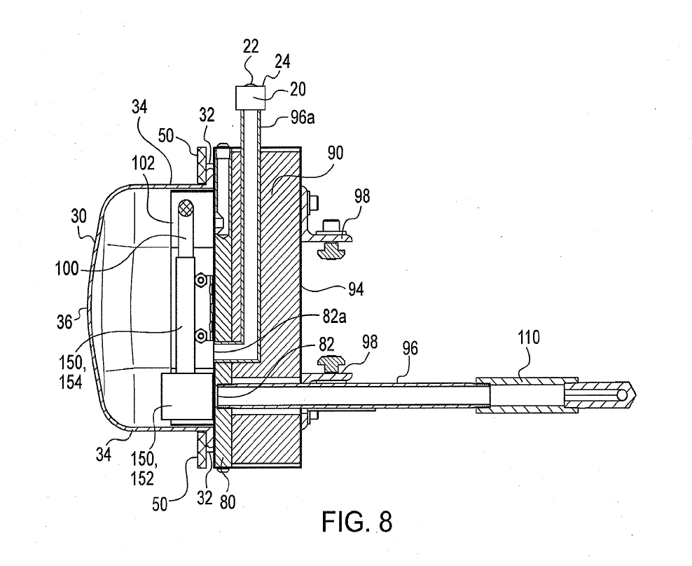

It will be understood that any one or more features described herein can be utilized in combination with any one or more other features or aspects described herein. For example, in certain embodiments of the present subject matter it may be preferred to utilize the exhaust conduit 96a and flow control valve 20 in combination with the air diffuser 150. This combination is described in greater detail in conjunction with FIGS. 7 and 8. Moreover, any or all of these aspects can be utilized in conjunction with one or more heaters as previously described herein.

FIGS. 7 and 8 illustrate the previously described flexible member 30 (in dashed lines in FIG. 7), frame 50, and enclosure 90 with the previously described exhaust conduit 96a, flow control valve 20, and air tube diffuser assembly 150. Air enters the diffuser 150 disposed within the interior of the flexible member 30 by passing through the conduit 96 and the aperture 82 defined in the vent plate 80. Once in the diffuser assembly, and specifically the base 152 of the diffuser 150, air is directed within the diffuser 150 and exits the diffuser 150 through one or more of the apertures, such as the apertures 156 (see FIG. 5), the optional apertures 153, and/or the aperture 155 (see FIG. 5). Additional air entering the diffuser 150 and exiting therefrom causes air within the interior of the flexible member 30 to exit that interior region through the aperture 82a defined in the vent plate 80. Exiting air, after having passed through the aperture 82a, is directed through the conduit 96a and exhausted to the atmosphere (or a receiving line or conduit) at aperture 24. In many versions, it is preferred to utilize a flow control valve 20 as shown along the exhaust conduit 96a to selectively adjust and/or control the pressure within the interior of the flexible member.

Many other benefits will no doubt become apparent from future application and development of this technology.

All patents, published applications, and articles noted herein are hereby incorporated by reference in their entirety.

As described hereinabove, the present subject matter overcomes many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A label processor comprising:
a rigid frame defining a front face and an oppositely directed rear face;
a flexible member sealingly attached to the frame, the flexible member defining an outer face for contacting a label, the flexible member defining a hollow interior region, the flexible member being deformable upon application of a label contacting force to a portion of the member;
wherein the rigid frame defines at least one air inlet and at least one air outlet in communication with the hollow interior region defined by the flexible member;
an air diffuser assembly disposed within the hollow interior region defined by the flexible member, the air diffuser assembly being in communication with the at least one air inlet such that air entering the air inlet travels through at least a portion of the air diffuser assembly to reach the hollow interior region defined by the flexible member.

2. The label processor of claim 1 wherein the air diffuser assembly includes a conduit defining a longitudinally extending interior flow channel and the conduit further defines a plurality of apertures providing communication between the interior flow channel of the conduit and the interior of the flexible member.

3. The label processor of claim 2 wherein at least a portion of the plurality of apertures are arranged in a plurality of rows extending along the conduit.

4. The label processor of claim 1 further comprising:
a heater disposed in the hollow interior region of the flexible member.

5. The label processor of claim 1 further comprising:
an exhaust assembly in communication with the at least one air outlet.

6. The label processor of claim 5 wherein the exhaust assembly includes a valve for adjusting air pressure within the hollow interior of the flexible member.

7. The label processor of claim 5 wherein the exhaust assembly includes:
an exhaust conduit extending between the hollow interior region defined by the flexible member and a region external to the flexible member, the exhaust conduit defining a longitudinally extending interior flow channel; and
at least one flow control valve for governing the flow of air within the longitudinally extending interior flow channel defined by the exhaust conduit.

8. The label processor of claim 1 wherein the frame defines an aperture through which the flexible member extends, the label processor further comprising:
a vent plate defining a front face and an oppositely directed rear face,
wherein at least a portion of the flexible member is disposed between the frame and the vent plate.

9. A label processor comprising:
a rigid frame defining a front face and an oppositely directed rear face, the frame defining an opening extending between the front and rear faces;
a flexible member extending through the opening defined in the frame and projecting outward from the front face of the frame, the flexible member defining an outer face for contacting a label, the flexible member defining a hollow interior region, the flexible member being deformable upon application of a label contacting force to a portion of the member;
a vent plate defining a front face and an oppositely directed rear face, the front face of the vent plate directed toward the rear face of the frame, the vent plate defining at least one air inlet and at least one air outlet in communication with the hollow interior region defined by the flexible member;
an exhaust assembly in communication with the at least one air outlet, the exhaust assembly including a valve for adjusting air pressure within the hollow interior of the flexible member.

10. The label processor of claim 9 further comprising:
a heater disposed in the hollow interior region of the flexible member.

11. The label processor of claim 9 further comprising:
an air diffuser assembly disposed within the hollow interior region defined by the flexible member, the air diffuser assembly being in communication with the at least one air inlet such that air entering the air inlet travels through at least a portion of the air diffuser assembly to reach the hollow interior region defined by the flexible member.

12. The label processor of claim 11 wherein the air diffuser assembly includes a conduit defining a longitudinally extending interior flow channel and the conduit further defines a plurality of apertures providing communication between the interior flow channel of the conduit and the interior of the flexible member.

13. The label processor of claim 12 wherein at least a portion of the plurality of apertures are arranged in a plurality of rows extending along the conduit.

14. A label processor comprising:
a rigid frame defining a front face and an oppositely directed rear face;
a flexible member sealingly attached to the frame, the flexible member defining an outer face for contacting a label, the flexible member defining a hollow interior region, the flexible member being deformable upon application of a label contacting force to a portion of the member;
wherein the rigid frame defines at least one air inlet and at least one air outlet in communication with the hollow interior region defined by the flexible member;
an exhaust assembly in communication with the at least one air outlet;
an air diffuser assembly disposed within the hollow interior region defined by the flexible member, the air diffuser assembly being in communication with the at least one air inlet such that air entering the air inlet travels through at least a portion of the air diffuser assembly to reach the hollow interior region defined by the flexible member.

15. The label processor of claim 14 further comprising:
an air inlet conduit in flow communication with at least one air inlet defined in the frame.

16. The label processor of claim 15 further comprising:
a preheater in flow communication with the air inlet conduit, wherein air within the air inlet conduit is heated by the preheater.

17. The label processor of claim 14 further comprising:
a heater disposed in the hollow interior region of the flexible member.

18. The label processor of claim 14 wherein the air diffuser assembly includes a conduit defining a longitudinally extending interior flow channel and the conduit further defines a plurality of apertures providing communication between the interior flow channel of the conduit and the interior of the flexible member.

19. The label processor of claim 18 wherein at least a portion of the plurality of apertures are arranged in a plurality of rows extending along the conduit.

20. The label processor of claim 14 wherein the exhaust assembly includes an exhaust conduit extending between the hollow interior region defined by the flexible member and a region external to the flexible member, the exhaust conduit defining a longitudinally extending interior flow channel, and at least one flow control valve for governing flow of air within the longitudinally extending interior flow channel defined by the exhaust conduit.

21. A method for promoting label application to a container by use of a label processor, the processor including (i) a frame, (ii) a flexible member sealingly attached to the frame, the flexible member defining an outer face for contacting a label, the flexible member defining a hollow interior region, the flexible member being deformable upon application of a label contacting force to a portion of the member, and (iii) an air diffuser assembly disposed within the hollow interior region defined by the flexible member, the method comprising:
directing air at a pressure greater than the pressure within the hollow interior region defined by the flexible member, into the air diffuser assembly;
distributing or directing the air within the hollow interior region defined by the flexible member as the air directed into the air diffuser, exits the air diffuser.

22. The method of claim 21 further comprising:
heating the air directed into the air diffuser assembly.

23. The method of claim 22 wherein heating of the air is performed such that the temperature along at least one region of the outer face of the flexible member is at least 38° C.

24. The method of claim 23 wherein the temperature is from about 120° C. to about 150° C.

25. The method of claim 21 further comprising:
heating the air after the distributed air exits the air diffuser.

26. The method of claim 25 wherein heating of the air is performed such that the temperature along at least one region of the outer face of the flexible member is at least 38° C.

27. The method of claim 26 wherein the temperature is from about 120° C. to about 150° C.

28. The method of claim 21 wherein the air diffuser assembly includes a conduit defining a longitudinally extending interior flow channel and the conduit further defines a plurality of apertures providing communication between the interior flow channel of the conduit and the interior of the flexible member.

29. The method of claim 28 wherein at least a portion of the plurality of apertures are arranged in a plurality of rows extending along the conduit.

30. The method of claim 21 wherein the label processor further includes (iv) an exhaust assembly in communication with the hollow interior region defined by the flexible member, the method further comprising:
exhausting air which exits the air diffuser from the interior region defined by the flexible member, through the exhaust assembly, to a region external to the flexible member.

31. The method of claim 30 wherein the exhaust assembly includes a valve for adjusting air pressure within the hollow interior of the flexible member and the method further comprising:
selectively changing the pressure within the hollow interior defined by the flexible member, by adjusting the valve.

32. The method of claim 31 wherein adjusting the valve is performed manually.

33. The method of claim 31 wherein adjusting the valve is performed by non-human means.
